(19) United States
(12) Patent Application Publication
(10) Pub. No.: US 2012/0162855 A1
(43) Pub. Date: Jun. 28, 2012

(54) CONDUCTIVE PASTE COMPOSITION FOR INTERNAL ELECTRODE, MULTILAYER CERAMIC CAPACITOR COMPRISING THE SAME AND METHOD OF MANUFACTURING THEREOF

(75) Inventors: Ju Myung SUH, Anyang (KR); Jun Hee Kim, Hwaseong (KR); Jang Ho Lee, Suwon (KR)

(73) Assignee: SAMSUNG ELECTRO-MECHANICS CO., LTD.

(21) Appl. No.: 13/167,268

(22) Filed: Jun. 23, 2011

(30) Foreign Application Priority Data
Dec. 24, 2010 (KR) 10-2010-0134785

(51) Int. Cl. H01G 4/008; B05D 5/12; H01B 1/22

(52) U.S. Cl. 361/305; 252/513; 427/123; 977/779

(57) ABSTRACT

There are provided a conductive paste composition for an internal electrode, and a multilayer ceramic capacitor comprising the same and a manufacturing method thereof. The conductive paste composition includes a metal powder, a dispersant made of an acrylic polymer having a weight average molecular weight of 500 to 5,000, and at least one organic binder selected from a group consisting of a polyvinylbutyral resin and a cellulose resin. The conductive paste composition for an internal electrode has superior dispersibility of the metal powder in the paste.

### CROSS-REFERENCE TO RELATED APPLICATIONS

This application claims the priority of Korean Patent Application No. 10-2010-0134785 filed on Dec. 24, 2010, in the Korean Intellectual Property Office, the disclosure of which is incorporated herein by reference.

### BACKGROUND OF THE INVENTION

1. Field of the Invention

The present invention relates to a conductive paste composition for an internal electrode, a multilayer ceramic capacitor comprising the same and a manufacturing method thereof and, more particularly, to a conductive paste composition for an internal electrode having excellent dispersibility, a multilayer ceramic capacitor comprising the same, and a manufacturing method thereof.

2. Description of the Related Art

In general, an electronic component using a ceramic material, such as a capacitor, an inductor, a piezoelectric device, a varistor, a thermistor, or the like, has a ceramic body made of the ceramic material, an internal electrode formed in the ceramic body, and an external electrode formed on a surface of the ceramic body to be connected to the internal electrode.

Among various ceramic components, a multilayer ceramic capacitor includes a plurality of laminated dielectric layers, internal electrodes arranged on opposite sides having each of the dielectric layers disposed therebetween, and external electrodes electrically connected to the internal electrodes.

The multilayer ceramic capacitor has advantages, for example, compactness, high capacity and ease of mounting, thus being widely used as a part of a mobile communications device such as a computer, a PDA, a mobile phone, or the like.

With the recent trend toward the lighter weight, smaller and higher performance products in electronic equipment industries, smaller, higher performance and lower cost electronic components are required. More particularly, since higher speed CPUs and smaller, lighter weight, digitalized and higher performance instruments have continually been made in recent years, numerous studies and investigations into improvements in various characteristics of a multilayer ceramic capacitor (hereinafter, referred to as an ‘MLCC’), such as decreased size and thickness, increased capacity and a low impedance at a high frequency range, or the like, have increasingly been implemented.

For a reduction in the size and an increase in the capacity of the MLCC, there has been a strong requirement for decreasing the thickness of a dielectric layer forming the MLCC. In recent years, a dielectric green sheet for the dielectric layer has a thickness of about several micrometers (μm) or less. In general, in order to manufacture the dielectric green sheet, a ceramic paste comprising a ceramic powder, a binder, a plasticizer and an organic solvent is initially prepared. Then, the ceramic paste is applied to a carrier sheet by a doctor blade method, followed by heating and drying processes.

Thereafter, a conductive paste for an internal electrode, which includes a metal powder, a binder, and the like is printed on the ceramic green sheet fabricated as above, in a predetermined pattern. By drying the treated sheet, an internal electrode pattern may be formed thereon. Through these processes, a plurality of ceramic green sheets having the internal electrode patterns formed thereon are formed. The ceramic green sheets having the internal electrode pattern formed thereon are stacked one after another up to a desired number of layers, resulting in a ceramic laminate. After cutting the ceramic laminate into chip shapes to manufacture green chips, the green chips are subjected to calcination. Additionally, an external electrode is formed on the prepared chips, to thereby fabricating a multilayer ceramic capacitor.

For a reduction in the size and an increase in the capacity of the multilayer ceramic capacitor, there is a need for decreasing the thicknesses of the internal electrode and the dielectric layer. Especially, an internal electrode layer needs to be thinner while having superior adhesiveness and leveling properties in order to prevent the separation thereof from a dielectric layer. An existing internal electrode paste has difficulties in realizing good adhesiveness and leveling properties, thus entailing limitations in use of fine metal powder.

### SUMMARY OF THE INVENTION

An aspect of the present invention provides a conductive paste composition for an internal electrode having excellent dispersibility, a multilayer ceramic capacitor comprising the same, and a manufacturing method thereof.

According to an aspect of the present invention, there is provided a conductive paste composition for an internal electrode, comprising: a metal powder; a dispersant made of an acrylic polymer having a weight average molecular weight of 500 to 5,000; and at least one organic binder selected from a group consisting of a polyvinylbutyral resin and a cellulose resin.

The metal powder may be at least one selected from a group consisting of nickel (Ni), manganese (Mn), chromium (Cr), cobalt (Co), aluminum (Al) and alloys thereof.

The metal powder may have a mean particle diameter of 200 nm or less.

The acrylic polymer may be a copolymer of a (meth)acrylic acid ester monomer containing an alkyl group having 1 to 10 carbon atoms.

A content of the dispersant may range from 0.1 to 5 parts by weight with respect to 100 parts by weight of the metal powder.

A content of the organic binder may range from 1 to 20 parts by weight with respect to 100 parts by weight of the metal powder.

The conductive paste composition for an internal electrode may further include 1 to 5 parts by weight of a phosphoric acid ester resin or a material having a salt bond between a carboxyl group in a fatty acid and an alkylamine, with respect to 100 parts by weight of the metal powder.

The conductive paste composition for an internal electrode may further include 1 to 20 parts by weight of a ceramic powder with respect to 100 parts by weight of the metal powder.

According to another aspect of the present invention, there is provided a multilayer ceramic capacitor, comprising: a ceramic body having a plurality of dielectric layers laminated therein; a plurality of internal electrodes, each of which is provided on each of the dielectric layers and formed by using a conductive paste comprising a metal powder, a dispersant made of an acrylic polymer having a weight average molecular weight of 500 to 5,000, and at least one organic binder selected from a group consisting of a polyvinylbutyral resin and a cellulose resin; and external electrodes formed on an outer surface of the ceramic body.

The metal powder may be at least one selected from a group consisting of Ni, Mn, Cr, Co, Al and alloys thereof.

The metal powder may have a mean particle diameter of 200 nm or less.

The acrylic polymer may be a copolymer of a (meth)acrylic acid ester monomer containing an alkyl group having 1 to 10 carbon atoms.

The conductive paste may further include a phosphoric acid ester resin or a material having a salt bond between a carboxyl group in a fatty acid and an alkylamine.

The conductive paste may further includes a ceramic powder.

According to aspect of the present invention, there is provided a method of manufacturing a multilayer ceramic capacitor, the method comprising: preparing a plurality of ceramic green sheets; forming internal electrodes on the ceramic green sheets by using a conductive paste which includes a metal powder, a dispersant made of an acrylic polymer having a weight average molecular weight of 500 to 5,000, and at least one organic binder selected from a group consisting of a polyvinylbutyral resin and a cellulose resin; laminating the ceramic green sheets having the internal electrodes formed therein, in order to form a ceramic laminate; and sintering the laminate.

The metal powder may be at least one selected from a group consisting of Ni, Mn, Cr, Co, Al and alloys thereof.

The metal powder may have a mean particle diameter of 200 nm or less.

The acrylic polymer may be a copolymer of a (meth)acrylic acid ester monomer containing an alkyl group having 1 to 10 carbon atoms.

The conductive paste may further include 1 to 5 parts by weight of a phosphoric acid ester resin or a material having a salt bond between a carboxyl group in a fatty acid and an alkylamine, with respect to 100 parts by weight of the metal powder.

The conductive paste may further include 1 to 20 parts by weight of a ceramic powder with respect to 100 parts by weight of the metal powder.

The internal electrode may have a surface roughness (Ra) in a range of 0.010 to 0.020 μm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view illustrating a multilayer ceramic capacitor according to an exemplary embodiment of the present invention, and FIG. 1B is a schematic cross-sectional view of the multilayer ceramic capacitor taken along line A-A′ shown in FIG. 1A;

FIGS. 2A and 2B are scanning electro microscope (SEM) images illustrating a surface of a conductive paste according to an inventive example of the present invention; and

FIGS. 3A and 3B are SEM images illustrating a surface of a conductive paste according to a comparative example.

### DETAILED DESCRIPTION OF THE EXEMPLARY EMBODIMENT

Hereinafter, exemplary embodiments will be described in detail with reference to the accompanying drawings. However, other modifications, variations and/or alterations thereof may be possible and the present invention is not particularly limited to the following embodiments. These exemplary embodiments are provided to more clearly understand the present invention by those skilled in the art to which the present invention pertains. Therefore, shapes and/or sizes of respective elements shown in the accompanying drawings may be enlarged for clarity and like reference numerals denote elements substantially having the same configurations or performing similar functions and actions throughout the drawings.

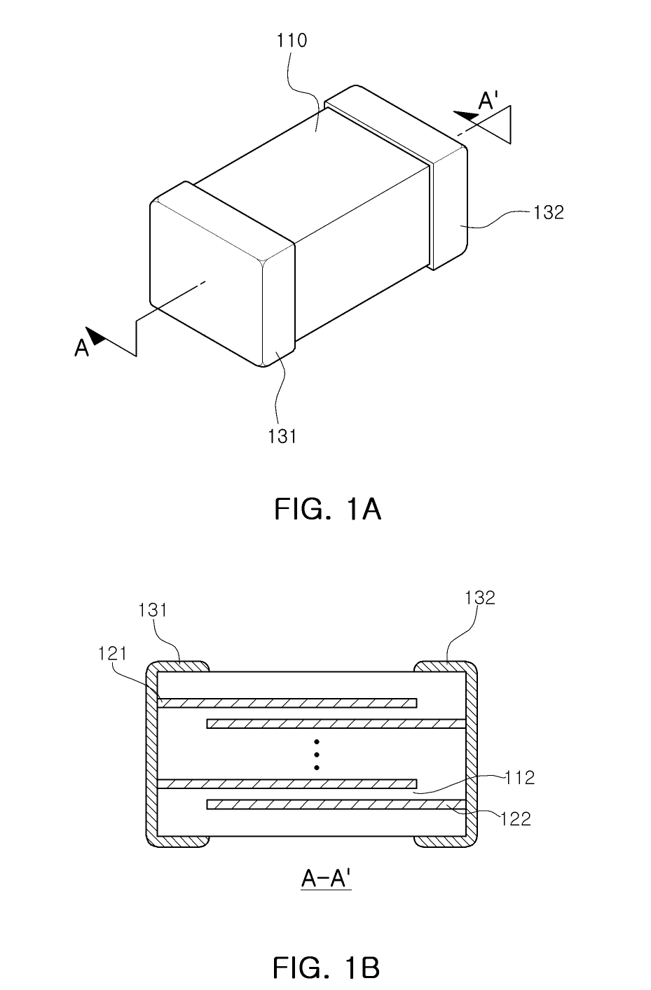

FIG. 1A is a schematic perspective view illustrating a multilayer ceramic capacitor according to an exemplary embodiment of the present invention, and FIG. 1B is a schematic cross-sectional view of the multilayer ceramic capacitor taken along line A-A′ shown in FIG. 1A.

Referring to FIGS. 1A and 1B, a multilayer ceramic capacitor according to the exemplary embodiment of the present invention includes: a ceramic body 110 having a plurality of laminated dielectric layers; a plurality of internal electrodes 121 and 122 formed on the dielectric layers; and external electrodes 131 and 132 formed on an outer surface of the ceramic body 110.

Shapes of the ceramic body 110 are not particularly limited, however, the ceramic body may have a rectangular parallelepiped shape. Also, a size of the ceramic body is not particularly limited, however, the size thereof may be 0.6 mm×0.3 mm. The multilayer ceramic capacitor may have excellent lamination performance and a high capacity of 22.5 μF or more.

The ceramic body 110 may be fabricated by laminating a plurality of dielectric layers 112. The plurality of dielectric layers 112 forming the ceramic body 110 are present in a sintered state, and may be integrated such that the boundaries between adjacent dielectric layers cannot be apparent.

Each of the dielectric layers 112 may be formed by sintering a ceramic green sheet containing a ceramic powder.

The ceramic powder may be not particularly limited as long as it could be generally used in the art. For instance, the ceramic powder may include a BaTiO₃ based ceramic powder. However, as the BaTiO₃ based ceramic powder, for example, (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like, which contains Ca, Zr, or the like in a BaTiO₃ ceramic powder, may also be used, however, the BaTiO₃ based ceramic powder is not limited thereto. A mean particle diameter of the ceramic powder may be 1.0 μm or less; however it is not particularly limited thereto.

In addition, the ceramic green sheet may include a transition metal oxide or a carbide, rare-earth elements, Mg, Al, or the like, as well as the ceramic powder.

A thickness of each dielectric layer 112 may be suitably varied depending on the capacity design of the multilayer ceramic capacitor. The thickness of the dielectric layer after sintering may be, for example, 1.0 μm or less; it is not limited thereto.

Inside the ceramic body 110, the plurality of internal electrodes 121 and 122 may be provided. The internal electrodes 121 and 122 are provided on each of the dielectric layers 112 and more particularly, may be formed on opposite sides of each dielectric layer 112 disposed therebetween in the ceramic body 110 through a sintering process.

The internal electrodes may be pairs of the first and second internal electrodes 121 and 122 having opposite polarities and arranged opposite to each other along the laminating direction of the dielectric layers. One ends of the first and second internal electrodes 121 and 122 may be alternately exposed to two opposing end surfaces of the ceramic body 110.

A thickness of the internal electrodes 121 and 122 may be suitably determined according to use thereof and may be, for example, 1.0 μm or less. Otherwise, the thickness may be determined in the range of 0.1 to 1.0 μm.

The internal electrodes 121 and 122 may be formed by using the conductive paste according to an exemplary embodiment of the present invention. The internal electrodes may be fabricated by printing the conductive paste on the ceramic green sheet and then firing the conductive paste. The printing may be performed by screen printing, gravure printing, or the like. These will be further described in detail.

The external electrodes 131 and 132 may be provided on an outer surface of the ceramic body 110 and electrically connected to the internal electrodes 121 and 122. More particularly, the external electrodes may include a first external electrode 131 electrically connected to the first internal electrode 121 which is exposed to one end surface of the ceramic body 110, and a second external electrode 132 electrically connected to the second internal electrode 122 which is exposed to the other end surface of the ceramic body 110.

The external electrodes 131 and 132 may be formed of the conductive paste containing a conductive material. Such a conductive material contained in the conductive paste is not particularly limited, however, may include, for example, Ni, Cu, or alloy thereof. A thickness of the external electrodes 131 and 132 may be suitably determined according to use thereof and, may range from 10 to 50 μm, for example.

The conductive paste composition for an internal electrode according to an exemplary embodiment of the present invention may include; a metal powder, a dispersant made of an acrylic polymer having a weight average molecular weight of 500 to 5,000, and at least one organic binder selected from the group consisting of a polyvinyl butyral resin and a cellulose resin.

The kinds of the metal powder contained in the conductive paste is not particularly limited, however, may include at least one selected from, for example, Ni, Mn, Cr, Co, Al, or alloy thereof.

A mean particle diameter of the metal powder is not particularly limited; however, it may be 200 nm or less. The mean particle diameter of the metal powder may be 120 nm or less and, preferably, may range from 50 to 120 nm.

In order to realize a highly laminated, high capacity multilayer ceramic capacitor, the thickness of the internal electrode needs to be decreased. In order to decrease the thickness of the internal electrode, fine metal powder needs to used. However, the fine metal powder may have difficulties in securing favorable dispersibility. However, even if such fine metal power is used, the dispersibility thereof in a paste may be secured.

The dispersant contained in the conductive paste may be an acrylic polymer having a low molecular weight. The acrylic polymer may have a weight average molecular weight ranging from 500 to 5,000. The acrylic polymer may be a copolymer of an (meth)acrylic acid ester monomer containing an alkyl group having 1 to 10 carbon atoms.

The (meth)acrylic acid ester monomer containing an alkyl group having 1 to 10 carbon atoms may be methylacrylate, ethylacrylate, propylacrylate, isopropylacrylate, butylacrylate, t-butylacrylate, pentylacrylate, 2-ethylhexylacrylate, octylacrylate, or the like, which may be used alone or in combination of two or more thereof.

The low molecular weight acrylic polymer is considered to surround surfaces of metal particles, thereby improving the dispersibility of the metal powder. When the weight average molecular weight of the acrylic polymer is less than 500, dispersion effects of the metal particles may not be obtained. On the other hand, when the weight average molecular weight of the acrylic polymer is more than 5,000, adhesion strength is excessively increased to cause agglomeration of metal particles.

A content of the acrylic polymer may range from 0.1 to 5 parts by weight with respect to 100 parts by weight of the metal powder. When the content is less than 0.1 parts by weight, fine metal powder particles may be aggregated. When the content is more than 5 parts by weight, the connectivity of the internal electrode may be deteriorated.

The conductive paste for an internal electrode according to an exemplary embodiment of the present invention may include at least one selected from the group consisting of a polyvinylbutyral resin and a cellulose resin, as an organic binder.

The polyvinylbutyral resin has excellent adhesion properties, thus improving the adhesion strength of the internal electrode paste.

The cellulose resin is not particularly limited and may include, for example, ethylcellulose, propylcellulose, or the like, which may be used in combination of one or more thereof. The cellulose resin has a chair structure and high resilience sufficient to be rapidly recovered by elasticity when deformation thereof is caused. Adding the cellulose resin to the paste may secure a flat surface to be printed.

A content of the organic binder may range from 1 to 20 parts by weight with respect to 100 parts by weight of the metal powder. When the content of the organic binder is less than 1 parts by weight, adhesiveness and printability may be deteriorated. On the other hand, when the content of the organic binder is more than 20 parts by weight, the dispersibility of the metal powder may be reduced or a carbon residue may remain during plasticization and calcination, thereby deteriorating characteristics of a multilayer ceramic capacitor and deteriorating connectivity of the internal electrode and coverage thereof.

The conductive paste composition for an internal electrode according to an exemplary embodiment of the present invention may further include a phosphoric acid ester resin, or a material having a salt bond between a fatty acid and an alkylamine, as a dispersant. A content of the dispersant may range from 1 to 5 parts by weight with respect to 100 parts by weight of the metal powder.

The phosphoric acid ester resin may be bonded to the surfaces of the metal particles to enhance the dispersibility of the metal particles. The phosphoric acid ester resin is not particularly limited, however, may include, for example, trimethylphosphate, triethylphosphate, tributylphosphate, trioctylphosphate, triphenylphosphate, tricresylphosphate, trixylylphosphate, cresyldiphenylphosphate, octyldiphenylphosphate, or the like, which may be used alone or in combination of two or more thereof.

The material having a salt bond between a fatty acid and an alkylamine may be represented by the following Formula:

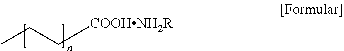

Where, n is an integer of 3 to 20, and R is an alkyl group having 1 to 10 carbon atoms.

The dispersant represented by the above Formula is a material having a salt bond between a carboxyl group in a fatty acid with an amine group in an alkylamine.

The conductive paste composition for an internal electrode according to an exemplary embodiment of the present invention may further include a plasticizer. The plasticizer may be a triethyleneglycol based plasticizer. A content of the plasticizer is not particularly limited, however, may range from 5 to 20 parts by weight with respect to 100 parts by weight of the metal powder.

Other than the foregoing materials, the conductive paste composition for an internal electrode according to an exemplary embodiment of the present invention may also include a ceramic powder in addition to these ingredients. As the ceramic powder is contained in the paste composition, sintering shrinkage of the internal electrode may be controlled. Additionally, in order to control characteristics of the ceramic powder, other additives such as dysprosium (Dy), barium (Ba), yttrium (Y), or the like may be further included.

A content of the ceramic powder may range from 1 to 20 parts by weight with respect to 100 parts by weight of the metal powder. The mean particle diameter of the ceramic powder is not particularly limited, however, may be 50 nm or less. The type of the ceramic powder may be substantially the same as that used for the dielectric layer.

According to an exemplary embodiment of the present invention, even when fine metal powder is used, the dispersibility of the metal powder may be improved, thus not causing the phase separation of the metal powder from the ceramic powder and securing excellent dispersibility of the fine ceramic powder.

A solvent added to the conductive paste composition for an internal electrode according to an exemplary embodiment of the present invention is not particularly limited, however, may include a solvent based on, for example, butyl carbitol, kerosene, terpineol, or the like. The terpineol solvent is not particularly limited, however, may include dihydroterpineol, dihydroterpinyl acetate, or the like.

The conductive paste composition for an internal electrode according to an exemplary embodiment of the present invention has excellent dispersibility of the metal powder. Therefore, even when fine metal powder is used, agglomeration of metal particles may be prevented and good printability and lamination performance may be secured.

When an internal electrode of a multilayer ceramic capacitor is formed by using the conductive paste composition for an internal electrode according to the exemplary embodiment of the present invention, it is possible to decrease a thickness of the internal electrode, reduce occurrence of short-circuit, and secure electrode connectivity. Accordingly, the multilayer ceramic capacitor may secure a capacity thereof and excellent electric properties such as reliability.

The following detailed description will be given to explain a process of manufacturing a multilayer ceramic capacitor by way of examples of the present invention. The multilayer ceramic capacitor according to an inventive example of the present invention may have an internal electrode formed by using the conductive paste composition as described above. A detailed description thereof will be given as follows.

According to the inventive example of the present invention, a plurality of ceramic green sheets may be prepared. Each of the ceramic green sheets is prepared in the form of a sheet having a thickness of several micrometers (μm). A ceramic powder is mixed with a binder and a solvent to prepare a slurry, and the prepared slurry is formed as the ceramic green sheet having the thickness of several micrometers (μm) by using a doctor blade method. Thereafter, the ceramic green sheet may be sintered. The sintered ceramic green sheet may be a dielectric layer forming a ceramic body.

Next, by applying a conductive paste for an internal electrode to the ceramic green sheet, first and second internal electrode patterns may be formed. The first and second internal electrode patterns may be formed by screen printing or gravure printing.

As the conductive paste for an internal electrode, the conductive paste for an internal electrode according to an embodiment of the present invention may be used, and constitutional ingredients and contents thereof are substantially the same as described above. The conductive paste for an internal electrode according to the present invention may improve the dispersibility of the metal powder, thus securing a uniform surface roughness and a high dry film density. The surface roughness (Ra) of the internal electrode pattern is not particularly limited, however, may range from 0.010 to 0.020 μm.

Moreover, the paste exhibits excellent printability and may be formed to have a thin thickness, thus enhancing the lamination performance thereof.

Thereafter, the ceramic green sheet as described above is laminated in plural and pressed in a laminating direction thereof to thereby allow the laminated ceramic green sheets to be compressed with the internal electrode pastes. As a result, a ceramic laminate having the ceramic green sheets and the internal electrode pastes laminated alternately may be fabricated.

Following this, the formed ceramic laminate is cut into chip pieces, each of which corresponds to one capacitor. Here, the cutting is carried out such that one ends of the first and second internal electrode patterns are alternately exposed through the cut sides of the ceramic laminate.

Afterward, the cut laminate chips are subjected to calcination, for example, at 1200° C. to thereby fabricate a ceramic body.

Next, first and second external electrodes are fabricated in such a manner as to be electrically connected to the first and second internal electrodes exposed to end surfaces of the ceramic body, respectively, while covering the end surfaces of the ceramic body. Lastly, the surfaces of the external electrodes may be subjected to plating using Ni, Sn, or the like.

Hereinafter, the present invention will be described in detail with reference to the following inventive example and comparative example, however, the scope of the present invention should not be construed as limited thereto.

### Example

A conductive paste was prepared by mixing 100 parts by weight of Ni powder having a mean particle diameter of 100 nm, 5 parts by weight of BaTiO₃ powder having a mean particle diameter of 20 nm and a phosphoric acid ester. Constitutional ingredients of the paste and contents thereof are shown in Table 1.

TABLE 1

| | Comparative Example | Inventive Example |
|---|---|---|
| Metal | Ni powder on the level | Ni powder on the |
| powder | of 100 nm | level of 100 nm |
| Dispersant | 5 parts by weight of a | 5 parts by weight of a |
| | phosphate ester and a material | phosphate ester and a |
| | having a salt bond between | material having a salt bond |
| | a fatty acid and an alkylamine | between a fatty acid and an |
| | | alkylamine, and 0.5 parts by |
| | | weight of an acrylic |
| | | dispersant having a weight |
| | | average molecular weight |
| | | of 2,500 |
| Organic | 5 parts by weight of | 5 parts by weight of |
| binder | polyvinylbutyral and ethyl | polyvinylbutyral and |
| | cellulose | ethyl cellulose |
| Solvent | Dihydroterpinyl acetate | Dihydroterpinyl acetate |
| Solid | 50 wt % | 50 wt % |
| content | | |

Characteristics of the conductive pastes according to the inventive example and the comparative example, such as surface roughness, viscosity, or the like, are shown in Table

TABLE 2

| | | Comparative | |
|---|---|---|---|
| | | Example | Example |
| Surface roughness (μm) | Ra | 0.057 | 0.016 |
| | Rₘₐₓ | 0.658 | 0.152 |
| | Rz | 0.605 | 0.132 |
| Viscosity (mPas) | 10 rpm | 21,000 | 10,000 |
| | 100 rpm | 6,300 | 3,800 |
| | 10/100 | 3.33 | 2.63 |

| | | |
|---|---|---|
| Dry film density (g/cm³) | 4.263 | 4.876 |
| Adhesion strength (N), ISO press | 0.510 | 0.600 |
| (1000 kgf, 30 min) | | |

Referring to Table 2, it was confirmed that the conductive paste according to the inventive example of the present invention has increased adhesion strength and excellent dispersibility, compared to those of the conductive paste according to the comparative example.

In the case of the conductive paste according to the comparative example, the surface roughness thereof was 0.1 μm or more (in terms of Ra=standard dispersion), which considerably exceeds a mass production standard (Ra<0.04 μm). Furthermore, compared to the conductive paste of the inventive example, the conductive paste of the comparative example shows a high viscosity. This is considered because of a decrease in dispersibility.

In the case of the conductive paste according to the inventive example of the present invention, the standard dispersion (Ra) of the surface roughness thereof was reduced to ⅓ of the standard dispersion of the conductive paste according to the comparative example. Moreover, a maximum roughness Rₘₐₓ caused by agglomeration of particles was reduced to ¼ of that of the conductive paste according to the comparative example.

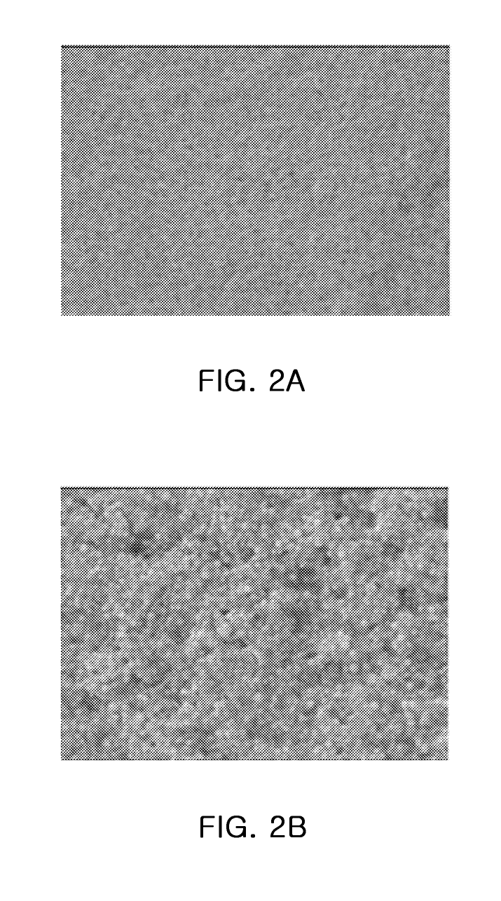

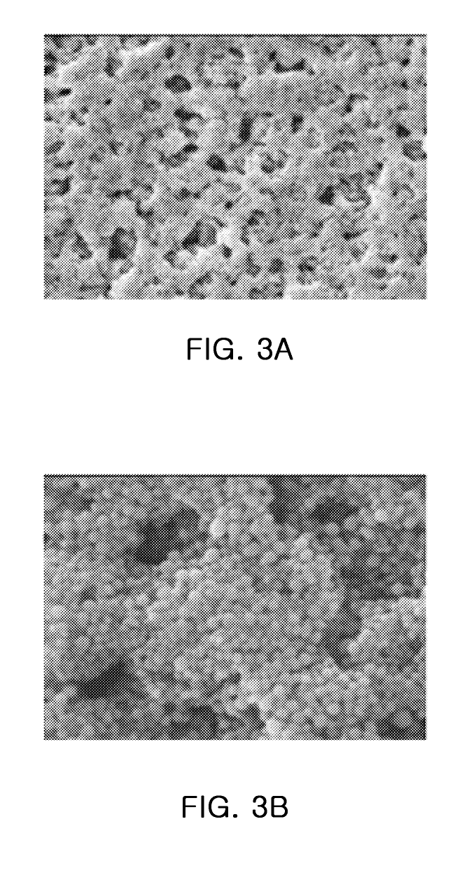

FIGS. 2A and 2B are, respectively, scanning electro microscope (SEM) images illustrating a surface of the conductive paste according to the foregoing inventive example, and FIGS. 3A and 3B are SEM images illustrating a surface of the conductive paste according to the comparative example. More particularly, FIGS. 2A and 3A show low magnification (×5,000) SEM images while FIGS. 2B and 3B show high magnification (×30,000) SEM images.

Referring to these images, Ni particles agglomeration and pores generated by the agglomeration were observed in the conductive paste according to the comparative example. On the contrary, it can be confirmed that Ni particles agglomeration and pores generated by the agglomeration are not present in the conductive paste according to the inventive example of the present invention.

Internal electrodes, each formed by using each of the conductive pastes according to the comparative example and the inventive example, are prepared to manufacture a multilayer ceramic capacitor having a 0603 size (0.6 mm×0.3 mm) and a capacity of 22.5 μF.

TABLE 3

| | Comparative | |
|---|---|---|
| | Example | Example |
| Electrode connectivity | 80.2 | 93.8 |
| Capacity (μF) | — | 2.268 |
| DF (%) | — | 0.043 |
| Rate of short-circuit | 100 | 23 |
| (%) | | |

Referring to Table 3, in case that the conductive paste according to the comparative example is used for an internal electrode, a short-circuit rate of 100% was caused in the internal electrode due to a decrease in dispersibility thereof within the internal electrode, thereby not allowing the electrical properties of the capacitor to be determined. Additionally, due to significant electrode aggregation, electrode connectivity was about 80%.

On the other hand, in case that the conductive paste according to the inventive example of the present invention is used for an internal electrode, it can be seen that dispersibility thereof in the internal electrode is improved while a short-circuit rate was decreased to 23%. In addition, the electrode aggregation was reduced, thus embodying a relatively high electrode connectivity of about 94%.

As described above, the conductive paste composition for an internal electrode according to exemplary embodiments of the present invention may have excellent dispersibility even when the composition contains fine metal powder. That is, the conductive paste according to the exemplary embodiments of the present invention may have a high surface roughness, a low viscosity and a high dry film density.

Moreover, the conductive paste composition for an internal electrode according to the exemplary embodiments of the present invention may have superior adhesiveness to a dielectric layer and excellent printing properties. Accordingly, delamination of the internal electrode from the dielectric layer does not occur during manufacturing a multilayer ceramic capacitor and, after plasticization and calcination, cracks are not generated.

When an internal electrode of a multilayer ceramic capacitor is formed by using the conductive paste for an internal electrode according to the present invention, a uniform internal electrode layer may be fabricated, such that the internal electrode layer exhibit improved connectivity after calcination. Moreover, even when a thin film internal electrode layer is formed and used, occurrence of short-circuit thereof may be reduced.

Consequently, the conductive paste composition according to the exemplary embodiments of the present invention may be effectively employed in developing ultra-small and ultra-high capacity electronic products that require a thin film internal electrode having a thickness of 1 μm or less.

The present invention is not particularly limited to the above preferred embodiments as well as the accompanying drawings but defined by the appended claims. Therefore, it will be apparent to those skilled in the art that various substitutions, modifications and/or variations can be made without departing from the spirit and scope of the invention, and duly included within the present invention.

What is claimed is:

1. A conductive paste composition for an internal electrode, the conductive paste composition comprising:
a metal powder;
a dispersant made of an acrylic polymer having a weight average molecular weight of 500 to 5,000; and
at least one organic binder selected from a group consisting of a polyvinylbutyral resin and a cellulose resin.

2. The conductive paste composition of claim 1, wherein the metal powder is at least one selected from a group consisting of nickel (Ni), manganese (Mn), chromium (Cr), cobalt (Co), aluminum (Al) and alloys thereof.

3. The conductive paste composition of claim 1, wherein the metal powder has a mean particle diameter of 200 nm or less.

4. The conductive paste composition of claim 1, wherein the acrylic polymer is a copolymer of a (meth)acrylic acid ester monomer containing an alkyl group having 1 to 10 carbon atoms.

5. The conductive paste composition of claim 1, wherein a content of the dispersant ranges from 0.1 to 5 parts by weight with respect to 100 parts by weight of the metal powder.

6. The conductive paste composition of claim 1, wherein a content of the organic binder ranges from 1 to 20 parts by weight with respect to 100 parts by weight of the metal powder.

7. The conductive paste composition of claim 1, further comprising 1 to 5 parts by weight of a phosphoric acid ester resin or a material having a salt bond between a carboxyl group in a fatty acid and an alkylamine, with respect to 100 parts by weight of the metal powder.

8. The conductive paste composition of claim 1, further comprising 1 to 20 parts by weight of a ceramic powder with respect to 100 parts by weight of the metal powder.

9. A multilayer ceramic capacitor, comprising:
a ceramic body having a plurality of dielectric layers laminated therein;
a plurality of internal electrodes, each of which is provided on each of the dielectric layers and formed by using a conductive paste comprising a metal powder, a dispersant made of an acrylic polymer having a weight average molecular weight of 500 to 5,000, and at least one organic binder selected from a group consisting of a polyvinylbutyral resin and a cellulose resin; and
external electrodes formed on an outer surface of the ceramic body.

10. The multilayer ceramic capacitor of claim 9, wherein the metal powder is at least one selected from a group consisting of Ni, Mn, Cr, Co, Al and alloys thereof.

11. The multilayer ceramic capacitor of claim 9, wherein the metal powder has a mean particle diameter of 200 nm or less.

12. The multilayer ceramic capacitor of claim 9, wherein the acrylic polymer is a copolymer of a (meth)acrylic acid ester monomer containing an alkyl group having 1 to 10 carbon atoms.

13. The multilayer ceramic capacitor of claim 9, wherein the conductive paste further includes a phosphoric acid ester resin or a material having a salt bond between a carboxyl group in a fatty acid and an alkylamine.

14. The multilayer ceramic capacitor of claim 9, wherein the conductive paste further includes a ceramic powder.

15. A method of manufacturing a multilayer ceramic capacitor, the method comprising:
preparing a plurality of ceramic green sheets;
forming internal electrodes on the ceramic green sheets by using a conductive paste which includes a metal powder, a dispersant made of an acrylic polymer having a weight average molecular weight of 500 to 5,000, and at least one organic binder selected from a group consisting of a polyvinylbutyral resin and a cellulose resin;
laminating the ceramic green sheets having the internal electrodes formed therein, in order to form a ceramic laminate; and
sintering the laminate.

16. The method of claim 15, wherein the metal powder is at least one selected from a group consisting of Ni, Mn, Cr, Co, Al and alloys thereof.

17. The method of claim 15, wherein the metal powder has a mean particle diameter of 200 nm or less.

18. The method of claim 15, wherein the acrylic polymer is a copolymer of a (meth)acrylic acid ester monomer containing an alkyl group having 1 to 10 carbon atoms.

19. The method of claim 15, wherein the conductive paste further includes 1 to 5 parts by weight of a phosphoric acid ester resin or a material having a salt bond between a carboxyl group in a fatty acid and an alkylamine, with respect to 100 parts by weight of the metal powder.

20. The method of claim 15, wherein the conductive paste further includes 1 to 20 parts by weight of a ceramic powder with respect to 100 parts by weight of the metal powder.

21. The method of claim 15, wherein the internal electrodes have a surface roughness Ra in a range of 0.010 to 0.020 μm.
